(19) United States
(12) Patent Application Publication
(10) Pub. No.: US 2016/0130125 A1
(43) Pub. Date: May 12, 2016

(54) Storage Container Opening And Closing Assist Devices And Kit Comprising Same

(71) Applicant: Mark McKinney, Soquel, CA (US)

(72) Inventor: Mark McKinney, Soquel, CA (US)

(21) Appl. No.: 14/706,929

(22) Filed: May 7, 2015

Related U.S. Application Data
(60) Provisional application No. 61/989,594, filed on May 7, 2014.

(51) Int. Cl. B67B 7/18

(52) U.S. Cl. CPC B67B 7/184

(57) ABSTRACT

A device for assisting a user in the opening and closing of jars and bottles. The device may have an outer band adapted to be attached around the outer surface of a lid or cap. The band may have a cross strap which keeps the band oriented in the proper location. The band may have serrated surfaces on the inside or the outside of the band to assist with frictional gripping. The band may be adapted to remain on the jar during the use life of the jar.

### CROSS REFERENCE TO RELATED APPLICATIONS

This application claims priority to U.S. Provisional Patent Application No. 61/989,594 to McKinney, filed May 07, 2014, which is hereby incorporated by reference in its entirety.

### BACKGROUND

1. Field of the Invention

This invention relates to a device, system, and kit for assisting with the removal and replacement of jar and bottle lids.

2. Description of Related Art

Caps and lids on bottles or jars are often secured tightly, and may also be of a very low profile, making them difficult to grasp, open, and close. Users may find it difficult to open and close some bottle lids and jar caps by hand. This concern may be highlighted in the cases of the elderly, or the very young.

Some devices are seen in the prior are which help a user open difficult lids. These devices typically are adapted to be used to open a difficult lid during the initial use of the jar, when the most force may be needed. These devices are also typically overly large, and adapted to be used to open a jar, and then put back into a drawer. These devices do not provide easy assistance to a user who seeks additional grip, and some additional leverage, in the opening and closing of jar lids, and the like, and who would prefer to have an assisting device remain on the jar.

What is called for is a device adapted to assist a user in the opening and closing of jars and bottles, and which is adapted to remain on the jar or bottle during the use life of the jar or bottle.

### SUMMARY

A device for assisting a user in the opening and closing of jars and bottles. The device may have an outer band adapted to be attached around the outer surface of a lid or cap. The band may have a cross strap which keeps the band oriented in the proper location. The band may have serrated surfaces on the inside or the outside of the band to assist with frictional gripping. The band may be adapted to remain on the jar during the use life of the jar.

BRIEF DESCRIPTION OF THE DRAWINGS

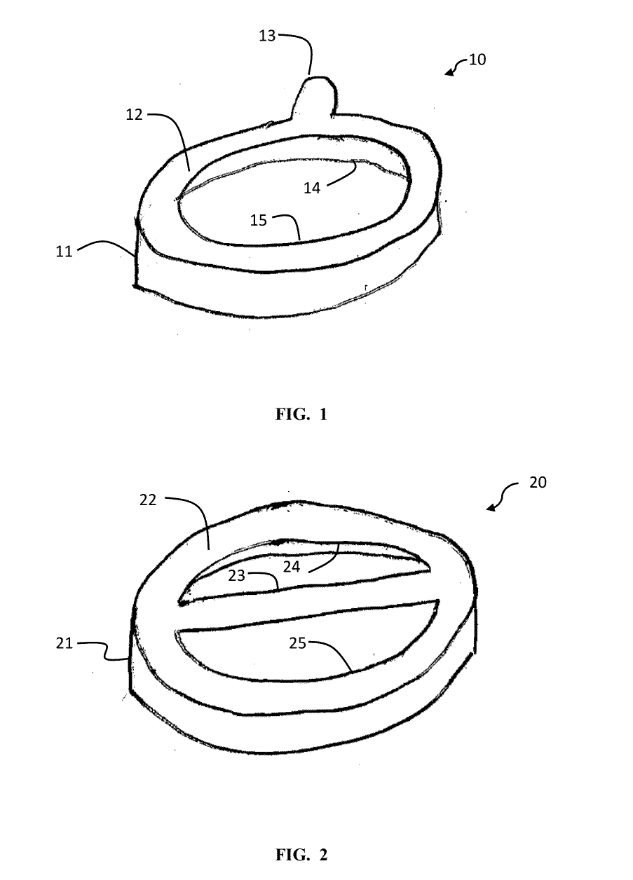

FIG. 1 is a view of a storage container opening and closing assist device according to some embodiments of the present invention.

FIG. 2 is a view of a storage container opening and closing assist device according to some embodiments of the present invention.

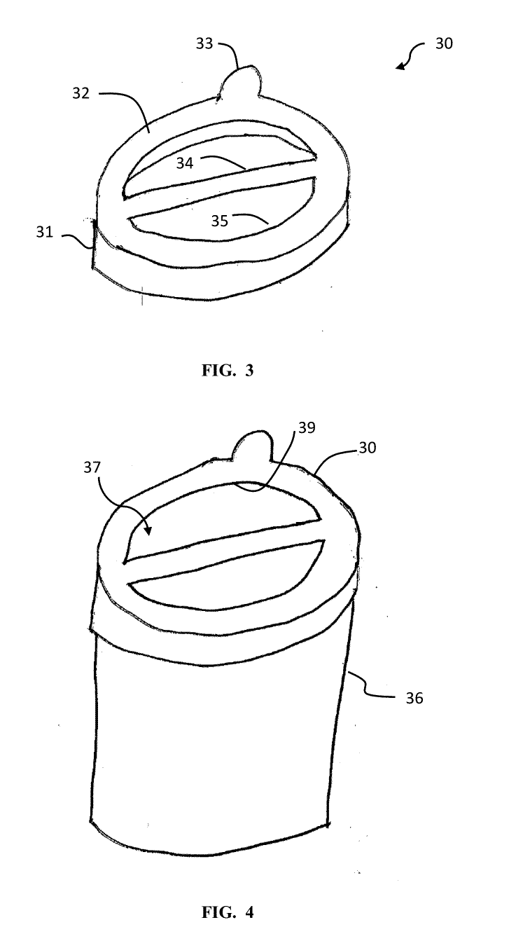

FIG. 3 is a view of a storage container opening and closing assist device according to some embodiments of the present invention.

FIG. 4 is a view of a storage container opening and closing assist device on a jar according to some embodiments of the present invention.

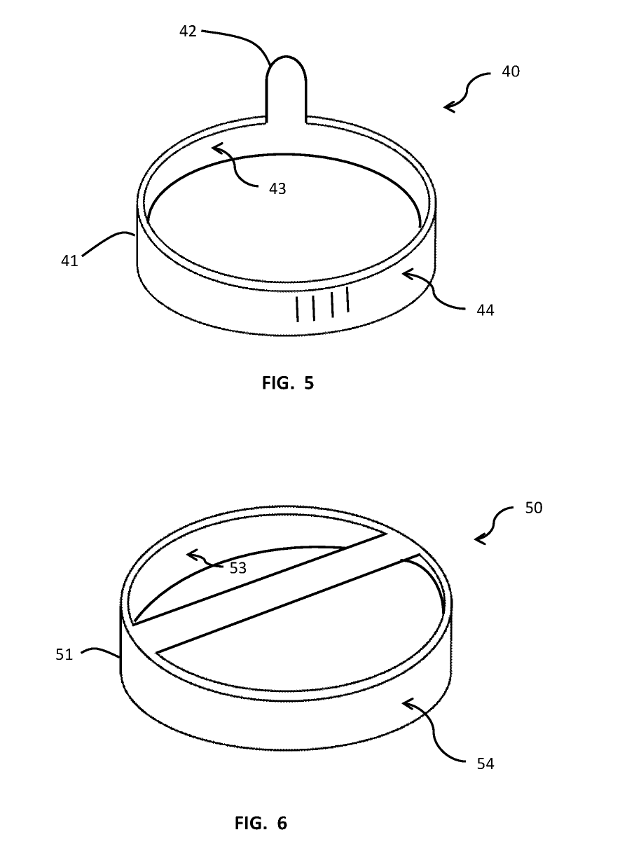

FIG. 5 is a view a storage container opening and closing assist device according to some embodiments of the present invention.

FIG. 6 is a view of a storage container opening and closing assist device according to some embodiments of the present invention.

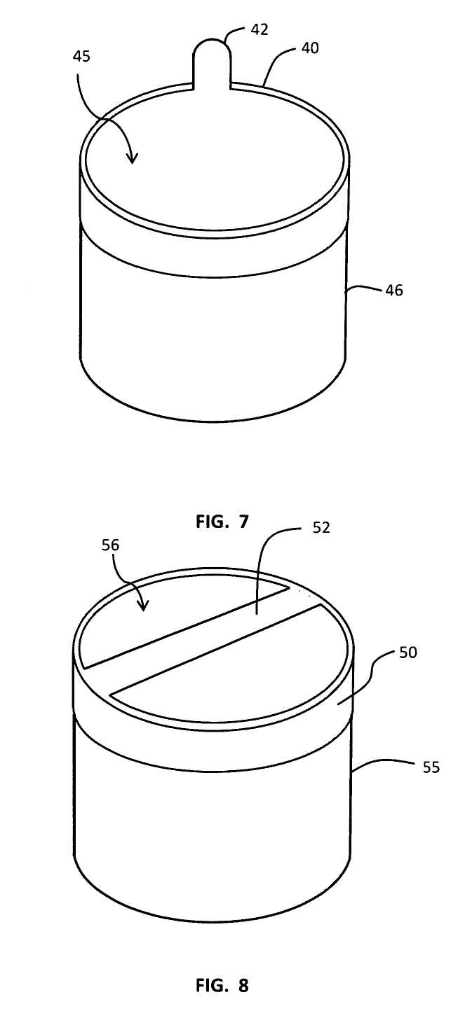

FIGS. 7 is a view of a storage container opening and closing assist device on a jar according to some embodiments of the present invention.

FIG. 8 is a view of a storage container opening and closing assist device on a jar according to some embodiments of the present invention.

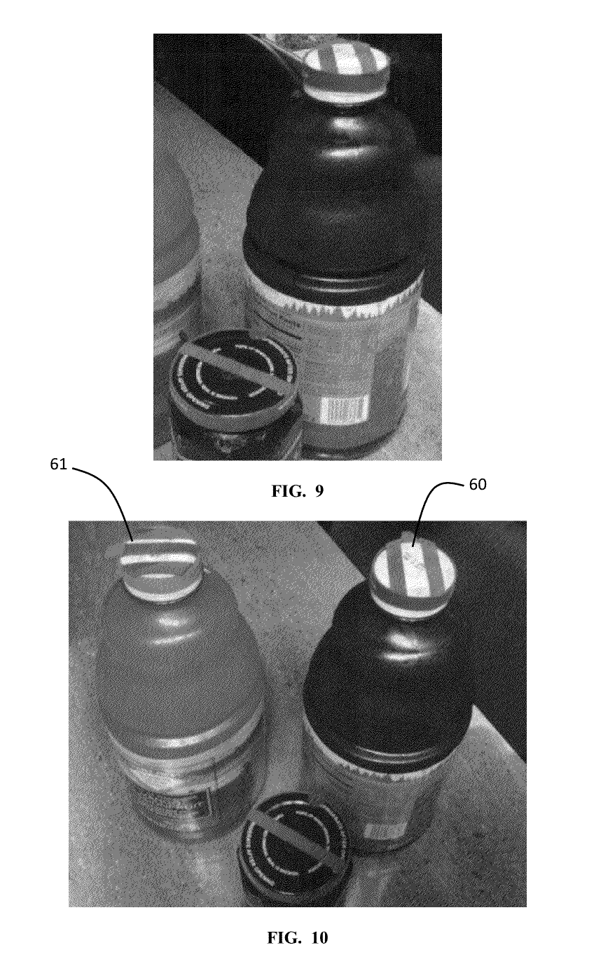

FIG. 9 is a photo of some storage container opening and closing assist devices on a jar and a bottle according to some embodiments of the present invention.

FIG. 10 is a photo of some storage container opening and closing assist devices on a jar and a bottle according to some embodiments of the present invention.

### DETAILED DESCRIPTION

In some embodiments of the present invention, as seen in FIG. 1, a storage container opening and closing assist device 10 has a cylindrical elastic band 11 adapted to be placed around the outside rim of a jar lid, or bottle cap. The band 11 may be attached to an annular elastic ring 12 which has an inner edge 15. A pull tab 13 may be attached to the cylindrical band, or to the annular ring, to assist in the removal of the device from a lid.

In use, the cylindrical band may be slightly stretched to go around the outside of the rim of a lid of a jar, for example. The device may be part of a kit of devices, of different sizes, to allow for a proper fit on the jar lid without undue stretching, or looseness. The elasticity of the band 11 may help keep the band in place around the edge of the lid. The ring 12 may assist in keeping the device from sliding down off of the lid onto the jar. An inner surface 14 of the band may be serrated in some aspects to allow for better frictional grabbing of the lid. The inner edge 15 of the annular ring 12 allows for the lid to be read, in that the contents of the jar may be discerned while the user is looking down at the jar from above, such as if the jar were in a door shelf in a refrigerator. The device is adapted to be left on a jar once placed on it, in that the device may assist a slightly enfeebled user to better open and close the jar. The device may remain with the jar, residing on the lid of the jar, until the jar is empty. At that time the device may be removed from the lid and reused.

In some embodiments of the present invention, as seen in FIG. 2, a storage container opening and closing assist device 20 has a cylindrical elastic band 21 adapted to be placed around the outside rim of a jar lid, or bottle cap. The band 21 may be attached to an annular elastic ring 22 which has an inner edge 25. A cross strap 23 is adapted to cross the annular opening in the top of device and may assist in keeping the device from sliding down the sides of a jar when in use. The use of a cross strap 23 still allows a user to see through down to the lid of the jar, which may assist in the identification of the contents of the jar. In some aspects, there may be a plurality of cross straps, which may run adjacent to each other, or may cross each other.

In some embodiments of the present invention, as seen in FIG. 3, a storage container opening and closing assist device 30 has a cylindrical elastic band 31 adapted to be placed around the outside rim of a jar lid, or bottle cap. The band 31 may be attached to an annular elastic ring 32 which has an inner edge 35. A cross strap 34 is adapted to cross the annular opening in the top of device and may assist in keeping the device from sliding down the sides of a jar when in use. The use of a cross strap 34 still allows a user to see through down to the lid of the jar, which may assist in the identification of the contents of the jar. In some aspects, there may be a plurality of cross straps, which may run adjacent to each other, or may cross each other. A pull tab 33 may be attached to the cylindrical band, or to the annular ring, to assist in the removal of the device from a lid.

FIG. 4 is an illustration of a storage container opening and closing assist device 30 in use on a jar 36 with a lid 37. The opening 39 in the top of the device 30 allows for the user to see the top surface 37 of the lid. In some aspects, the outer surface of the cylindrical elastic band may be serrated to allow for alternate gripping. In some aspects, the inner surface of the cylindrical band may be serrated to allow for different gripping. In some aspects, both the inner and outer surface of the cylindrical band may be serrated, or otherwise roughened.

In some embodiments of the present invention, as seen in FIG. 5, a storage container opening and closing assist device 40 has a cylindrical elastic band 41 adapted to be placed around the outside rim of a jar lid, or bottle cap. The band 41 may be attached to a pull tab 13. The pull tab 13 may assist in the removal of the device from a lid.

In some embodiments of the present invention, as seen in FIG. 6, a storage container opening and closing assist device 50 has a cylindrical elastic band 51 adapted to be placed around the outside rim of a jar lid, or bottle cap. A cross strap 52 is adapted to cross the annular opening in the top of device and may assist in keeping the device from sliding down the sides of a jar when in use. The use of a cross strap 52 still allows a user to see through down to the lid of the jar, which may assist in the identification of the contents of the jar. In some aspects, there may be a plurality of cross straps, which may run adjacent to each other, or may cross each other. In some aspects, the inner surface 53 of the cylindrical band 51 may be serrated, or otherwise altered, to allow for a better grip on the lid. In some aspects, the outer surface 54 of the cylindrical band 51 may be serrated, or otherwise altered, to allow for a better grip of the device by the user.

In some aspects, the storage container opening and closing assist device may be made from rubber or a rubberized compound. In some aspects, the device may be made from another type of elastic, or mildly elastic, material.

FIG. 7 is an illustration of a storage container opening and closing assist device 40 in use on a jar 46 with a lid 45. The opening in the top of the device 40 allows for the user to see the top surface 45 of the lid. In some aspects, the outer surface of the cylindrical elastic band may be serrated to allow for alternate gripping. In some aspects, the inner surface of the cylindrical band may be serrated to allow for different gripping. In some aspects, both the inner and outer surface of the cylindrical band may be serrated, or otherwise roughened.

FIG. 8 is an illustration of a storage container opening and closing assist device 50 in use on ajar 55 with a lid 56. The opening in the top of the device 30 allows for the user to see the top surface 56 of the lid, despite the presence of the cross strap 52.

FIGS. 9 and 10 are photographs illustrating storage container opening and closing assist devices 60, 61 in use on actual bottles and jars. As seen, the lid of the jar can be seen, and thus the contents recognized, even though there is a cross strap which will keep the band from slipping down off of the lid.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A jar opening and closing assist device, said device comprising:
a cylindrical elastic band adapted to slip over the outer surface of a jar lid or bottle cap; and
a pull tab extending from said cylindrical band.

2. The jar opening and closing assist device of claim 1 further comprising a cross strap, said cross strap extending from a first point on an edge of said cylindrical band to a second point on the edge of said cylindrical band across the diameter of said cylindrical band.

3. The jar opening and closing assist device of claim 1 further comprising an annular elastic ring, said annular elastic ring attached to an edge of said cylindrical elastic band.

4. The jar opening and closing assist device of claim 3 further comprising a cross strap, said cross strap extending from a first point on an inner edge of said annular elastic ring to a second point on an inner edge of said annular elastic ring across the diameter of said cylindrical band.

5. The jar opening and closing assist device of claim 1 further comprising a plurality of cross straps, said cross straps extending from a point on an edge of said cylindrical band to a point on the edge of said cylindrical band.

6. The jar opening and closing assist device of claim 3 further comprising a plurality of cross straps, said cross straps extending from a point on an inner edge of said annular elastic ring to a different point on an inner edge of said annular elastic ring.

7. The jar opening and closing assist device of claim 1 wherein said cylindrical elastic band has an inner surface and an outer surface, and wherein said inner surface comprises a serrated surface.

8. The jar opening and closing assist device of claim 1 wherein said cylindrical elastic band has an inner surface and an outer surface, and wherein said outer surface comprises a serrated surface.

9. The jar opening and closing assist device of claim 7 wherein said outer surface comprises a serrated surface.

10. A jar opening and closing assist device, said device comprising:
a cylindrical elastic band adapted to slip over the outer surface of a jar lid or bottle cap; and
a cross strap, said cross strap extending from a first point on atop edge of said cylindrical band to a second point on the top edge of said cylindrical band across the diameter of said cylindrical band.

11. The jar opening and closing assist device of claim 10 wherein said cylindrical elastic band has an inner surface and an outer surface, and wherein said inner surface comprises a serrated surface.

12. The jar opening and closing assist device of claim 10 wherein said cylindrical elastic band has an inner surface and an outer surface, and wherein said outer surface comprises a serrated surface.

13. The jar opening and closing assist device of claim 11 wherein said outer surface comprises a serrated surface.

14. A kit of jar opening and closing assist devices, said kit comprising;
a plurality of jar opening and closing assist devices, said devices comprising:
a cylindrical elastic band adapted to slip over the outer surface of a jar lid or bottle cap; and
a pull tab extending from said cylindrical band.
